(19) United States
(12) Patent Application Publication
(10) Pub. No.: US 2007/0219337 A1
(43) Pub. Date: Sep. 20, 2007

(54) Preparation of storage-stable, isocyanate-functional prepolymers using NCO-functional carbonyl and carbamoyl halides

(76) Inventors: Burkhard Kohler, Leverkusen (DE); Steffen Hofacker, Odenthal (DE)

Correspondence Address: BAYER MATERIAL SCIENCE LLC, 100 BAYER ROAD, PITTSBURGH, PA, 15205, US

(21) Appl. No.: 11/717,541

(22) Filed: Mar. 13, 2007

(30) Foreign Application Priority Data
Mar. 18, 2006 (DE) 102006015280.8

(51) Int. Cl. C08G 18/00

(52) U.S. Cl. 528/44

(57) ABSTRACT

The invention relates to storage-stable isocyanate-functional prepolymers, to a process for the preparation, and also to their use as a starting component in the production of polyurethane plastics, of paints and coatings, of adhesives and of sealants.

### CROSS-REFERENCE TO RELATED APPLICATIONS

The present application claims the right of priority under 35 U.S.C. §119 (a)-(d) of German Patent Application Number 10 2006 015 280.8, filed Mar. 18, 2006.

### BACKGROUND OF THE INVENTION

The invention relates to storage-stable isocyanate-functional prepolymers, to a process for their preparation, and also to their use as a starting component in the production of polyurethane plastics, paints and coatings, adhesives and sealants.

In polyurethane chemistry the term isocyanate-functional prepolymers is understood to refer to (oligomeric) urethanes having at least one free isocyanate group. These compounds, as is known, are obtainable through the reaction of polyisocyanates with polyols in an equivalents ratio of the NCO groups to the OH groups of ≧2:1.

Prepolymers of this kind constitute important building blocks for crosslinking with polyols or amines in the production of polyurethane-based or polyurea-based paints, coatings, sealants and adhesives. Isocyanate-functional prepolymers are also of particular interest for moisture-curing one-component (“1 K”) systems. Application is followed by crosslinking under the influence of atmospheric moisture, with formation of urea groups.

A desirable quality, not only for use in two-component (“2 K”) systems, but especially for use in moisture-curing 1 K systems, is a high level of storage stability on the part of the NCO prepolymers. By storage stability is meant in this context a high stability towards hydrolysis during storage—in other words, a low level of loss of free NCO groups and, in concert therewith, an extremely low increase in viscosity during storage.

U.S. Pat. No. 3,183,112 describes the preparation of isocyanate-functional prepolymers by reaction of a polyol containing ether groups and having molar masses of 196 to 12000 g/mol with at least twice the equivalent amount of diisocyanate. The working-up which follows, and which is necessary for removal of residual monomer, takes place by means of thin-film distillation. The products, however, are often not stable on storage, but instead are subject to isocyanate degradation, which goes hand in hand with a rise in viscosity.

The stabilization of prepolymers of this kind using titanium tetrachloride is described in U.S. Pat. No. 3,723,394. In this case, after thin-filming, titanium compounds remain in the prepolymer and, as a result of their catalytic action, they increase the reactivity of the isocyanate groups, and as a result of their photocatalytic action, they increase the UV-susceptibility of the resultant polyurethanes. Moreover, titanium hydroxides and titanium oxides formed in the course of storage are the cause of unwanted clouding in the products.

U.S. Pat. No. 4,738,991 describes storage-stable polyisocyanates which carry allophanate groups and wherein the stabilization is accomplished by means of aliphatic, aromatic or inorganic acid chlorides. A disadvantage is the high volatility of the stabilizers, meaning that they are easily removed in the course of thin-filming.

The object of the present invention was to provide isocyanate-functional prepolymers which are storage-stable, i.e. do not exhibit any significant rise in viscosity during the storage time, and which do not have the disadvantages of the prior art.

It has now been found that the underlying object is achieved by using NCO-functional carbonyl halides or carbamoyl halides for the purpose of stabilization in the course of the prepolymer preparation. The halides are incorporated into the prepolymer by way of the NCO group and therefore can no longer be removed by distillation.

### SUMMARY OF THE INVENTION

The invention according provides isocyanate-functional prepolymers comprising at least one structural unit of the general formula (I) or (II)

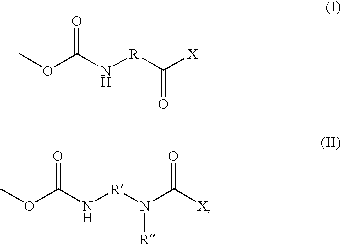

where
R and R′ independently of one another are a C₁ to C₁₂ alkylene, a C₅ to C₁₂ cycloalkylene or an optionally heteroatom-containing, aromatic hydrocarbon radical having 6 to 22 carbon atoms,
R″ is a C₁ to C₁₂ alkyl, a C₅ to C₁₂ cycloalkyl or an optionally heteroatom-containing, aromatic hydrocarbon radical having 6 to 22 carbon atoms, and
X is a halogen atom.

Preferably R and R′ are o-, m-, or p-phenylene radicals, a 1,5-pentylene radical or 2,4- or 2,6-toluene radicals.

Preferably R″ is a C1 to C4 alkyl radical.

Preferably is X is Cl.

The isocyanate prepolymers of the invention can of course also include structural units of both formula, (I) and (II).

The invention further provides a process for preparing the prepolymers of the invention, in which
a) one or more polyisocyanates are reacted with
b) one or more polyols in the presence of
c) at least one isocyanatocarbonyl halide or isocyanatocarbamoyl halide of the general formula (III) or (IV), respective

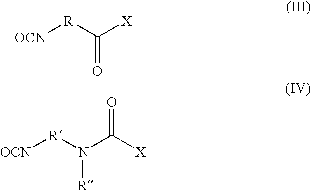

where

### R, R′, R″ and X meet the conditions already defined above.

### DETAILED DESCRIPTION OF THE PREFERRED EMBODIMENTS

As suitable polyisocyanates of component a) use is made of the aromatic, araliphatic, aliphatic or cycloaliphatic polyisocyanates with an NCO functionality of preferably ≧2 that are known per se to the person skilled in the art. These polyisocyanates may also contain iminooxadiazinedione, isocyanurate, uretdione, urethane, allophanate, biuret, urea, oxadiazinetrione, oxazolidinone, acylurea and/or carbodiimide structures.

The aforementioned polyisocyanates are based on diisocyanates and triisocyanates that are known per se to the person skilled in the art and contain aliphatically, cycloaliphatically, araliphatically and/or aromatically attached isocyanate groups, it being immaterial whether these isocyanates have been prepared using phosgene or by phosgene-free processes. Examples of such diisocyanates and triisocyanates are 1,4-diisocyanatobutane, 1,5-diisocyanatopentane, 1,6-diisocyanatohexane (HDI), 2-methyl-1,5-diisocyanatopentane, 1,5-diisocyanato-2,2-dimethylpentane, 2,2,4- and 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane (Desmodur® W, Bayer AG, Leverkusen, DE), 4-isocyanatomethyl-1,8-octane diisocyanate (triisocyanatononane, TIN), ω,ω′-diisocyanato-1,3-dimethylcyclohexane (H₆XDI), 1-isocyanato-1-methyl-3-isocyanatomethylcyclohexane, 1-isocyanato-1-methyl-4-isocyanatomethylcyclohexane, bis(isocyanatomethyl)norbornane, 1,5-naphthalene diisocyanate, 1,3- and 1,4-bis(2-isocyanatoprop-2-yl)benzene (TMXDI), 2,4- and 2,6-diisocyanatotoluene (TDI) especially the 2,4 and the 2,6 isomer and technical mixtures of the two isomers, 2,4′- and 4,4′-diisocyanatodiphenylmethane (MDI), 1,5-diisocyanatonaphthalene, 1,3-bis(isocyanatomethyl)benzene (XDI), and any desired mixtures of said compounds.

With particular preference these polyisocyanates of component a) have an average NCO functionality of 2.0 to 5.0, with very particular preference of 2.3 to 4.5, and preferably an isocyanate group content of 5.0 to 27.0% by weight, with particular preference of 14.0 to 24.0% by weight, and, preferably, a monomeric diisocyanate content of less than 1% by weight, with particular preferably less than 0.5% by weight.

In component a) polyisocyanates or polyisocyanate mixtures of the aforementioned kind containing exclusively aliphatically and/or cycloaliphatically attached isocyanate groups are used with preference.

With particular preference the polyisocyanates of the aforementioned kind are based on hexamethylene diisocyanate, isophorone diisocyanate, the isomeric bis(4,4′-isocyanatocyclohexyl)methanes, TDI, MDI, and mixtures thereof.

As suitable polyols of component b) it is possible to use all of the polyols known per se to a person skilled in the art from polyurethane chemistry which preferably have an average OH functionality ≧1.5, with particular preference from 1.8 to 2.5.

These may be, for example, low molecular weight diols (e.g. 1,2-ethanediol, 1,3- and/or 1,2-propanediol, 1,4-butanediol), triols (e.g. glycerol, trimethylolpropane) and tetraols (e.g. pentaerythritol), polyether polyols, polyester polyols, polyacrylate polyols and polycarbonate polyols. Preferred polyols are polyether-based substances of the aforementioned kind.

When using polyether polyols in component b) use is made of polyether polyols with a number-average molecular weight Mₙ of preferably 300 to 20000 g/mol, with particular preference 1000 to 12000 g/mol, with very particular preference 2000 to 6000 g/mol.

Furthermore they possess preferably an average OH functionality of ≧1.9, with particular preference ≧1.95.

The OH functionality of these polyethers is preferably <6, more preferably <4, very preferably <2.2.

Polyether polyols of this kind are accessible in conventional wires through alkoxylation of suitable starter molecules with base catalysis or through use of double-metal cyanide compounds (DMC compounds).

Particularly preferred polyether polyols of component b) are those of the aforementioned kind having an unsaturated end group content of less than or equal to 0.02 milliequivalent per gram of polyol (meq/g), preferably less than or equal to 0.015 meq/g, with particular preference less than or equal to 0.01 meq/g (method of determination: ASTM D2849-69).

Polyether polyols of this kind have a particularly narrow molecular weight distribution, i.e. a polydispersity (PD=M_{w}/Mₙ) of 1.0 to 1.5 and/or an OH functionality ≧1.9. With preference the stated polyether polyols have a polydispersity of 1.0 to 1.5 and an OH functionality of greater than 1.9, with particular preference greater than or equal to 1.95.

Polyether polyols of this kind are preparable in conventional wires through alkoxylation of suitable, preferably difunctional, starter molecules, in particular using double-metal cyanide catalysts (DMC catalysis). This is described for example in U.S. Pat. No. 5,158,922 (e.g. Example 30) and EP-A 0 654 302 (p. 5, 1.26 to p. 6, 1.32).

Suitability for the alkoxylation is possessed by cyclic ethers such as tetrahydrofuran, ethylene oxide, propylene oxide, butylene oxide, styrene oxide or epichlorohydrin, which may be used in any order or else in a mixture during the alkoxylation. Preferred for the alkoxylation are ethylene oxide, propylene oxide and tetrahydrofuran (THF).

Examples of suitable starter molecules for the preparation of polyether polyols are simple, low molecular weight polyols, water, organic polyamines having at least two N—H bonds, or any desired mixtures of such starter molecules.

Preferred starter molecules for preparing polyether polyols by alkoxylation, especially by the DMC process, are simple polyols such as ethylene glycol, 1,3-propylene glycol and 1,4-butanediol, 1,6-hexanediol, neopentyl glycol, 2-ethylhexane-1,3-diol, glycerol, trimethylolpropane, trimethylolethane, pentaerythritol, and also low molecular weight, hydroxyl-containing esters of such polyols with dicarboxylic acids, or low molecular weight of ethoxylation or propoxylation products of such simple polyols, or any desired mixtures of polyhydroxy compounds of this kind.

Particularly preferred starters are difunctional alcohols of the aforementioned type.

Likewise suitable as compounds of component b) are polyester polyols formed from the condensation reaction of suitable alcohols and acids. Alcohols employed here are primary and diprimary diols, such as ethylene glycol, diethylene glycol, triethylene glycol, 1,2-propylene glycol, dipropylene glycol, 1,3-butanediol, 1,4-butanediol, 1,6-hexanediol or neopentyl glycol, and also higher polyfunctional alcohols, such as trimethylolpropane, trimethylolethane or pentaerythritol. Suitable condensation partners are acid components such as adipic acid or the phthalic acids. Additionally the ring-opening polymerization of ε-caprolactone or methyl-ε caprolactone using metal catalysts such as Sn(II) ethylhexanoate or titanium tetraalkoxylates and diols or triols of the aforementioned kind as starters leads to suitable polyester polyols of component b). The length of the polyester polyol in this context can be determined by the number of caprolactone units used.

The preferred molecular weight of the polyester polyols (numerical average) amounts to ≦1000 g/mol. The preferred functionality of the polyester polyols amounts to 2 to 3.

Polyacrylate polyols as well are suitable for preparing the prepolymers of the invention of component b). The polyacrylate polyols have a number-average molecular weight of 200 to 10000 g/mol, with particular preference 200 to 6000 g/mol and with very particular preference 200 to 2500 g/mol. The functionality of the polyacrylate polyols employed is preferably 1.6 to 3.8, with particular preference 1.8 to 3.5. The OH number of these polyacrylate polyols is preferably 15 to 150, with particular preference 20 to 100 and with very particular preference 40 to 80 mg KOH/g. Suitable examples include Acryflow® P60 and P90 (commercial products from. Lyondell, US).

Aliphatic polycarbonate polyols, too, are suitable for synthesizing the prepolymers of the invention of component b). Polycarbonate polyols can be obtained, as is known, from the condensation reaction of phosgene with polyols or from the transesterification of suitable organic carbonates with polyols. Suitable organic carbonates include aryl alkyl alkylene carbonates and mixtures thereof. Examples that may be mentioned include diphenyl carbonate (DPC), dimethyl carbonate (DMC), diethyl carbonate (DEC), and ethylene carbonate. Suitable polyols include those specified above in the section on polyester polyols. The functionality of the polycarbonate polyols employed is preferably 1.6 to 3.8, with particular preference 1.8 to 3.5. These polycarbonate polyols have a number-average molar weight of preferably 100 to 6000 g/mol and with particular preference of 100 to 4000 g/mol. The OH number is dependent on the functionality of polycarbonate polyols and typically 20 to 900 mg KOH/g.

Particularly preferred compounds of the formula (III) are 6-isocyanatocaproyl chloride, 11-isocyanatoundecanoyl chloride, and o-, m- or p-isocyanatobenzoyl chloride. Particularly preferred compounds of the formula (IV) are 2-chlorocarbamoyl-ethylamino-4-isocyanatotoluene and 4-chlorocarbamoyl-ethylamino-2-isocyanatotoluene.

The polyurethane prepolymers of the invention are prepared in principle in the manner known from polyurethane chemistry. In this case the polyols of component b) (individually or as a mixture) are reacted with an excess of the isocyanate component a) (individually or as a mixture) and with at least one halide of component c) in the presence, if desired, of a catalyst and/or of auxiliaries and additives. The homogeneous reaction mixture is stirred until a constant NCO value is obtained. After that it is possible for any unreacted polyisocyanate to be removed by continuous distillation.

Components a), b) and c) can be reacted, as initially described above, in a single reaction step. An alternative possibility is first to react the halide of component c) with the polyol or the polyol mixture of component b) and then, in a further reaction step, to add the isocyanate component in excess.

By a continuous distillation process in the sense of the invention is meant process in which only one respective portion of the prepolymer from process step I) is exposed for a short time to an increased temperature, while the amount not yet part of the distilling operation remains at a substantially lower temperature. An increased temperature is that for the evaporation of the volatile constituents under a correspondingly selected pressure.

Preferably the distillation is carried out at a temperature of less than 170° C., with particular preference 110 to 170° C., with very particular preference 125 to 145° C., and under pressures of less than 20 mbar, with particular preference less 10 mbar, with very particular preference 0.05 to 5 mbar.

The temperature of the amount of the prepolymer-containing reaction mixture that is not yet part of the distilling operation is preferably 0 to 60° C., with particular preference 15 to 40° C. and with very particular preference 20 to 40° C.

In one preferred embodiment of the invention the temperature difference between the distillation temperature and the temperature of the amount of prepolymer-containing reaction mixture that is not yet part of the distilling operation is at least 5° C., with particular preference 15° C., with very particular preference 15 to 40° C.

The distillation is preferably carried out at a rate such that one volume increment of the prepolymer-containing reaction mixture for distillation is exposed for less then 10 minutes, with particular preference less than 5 minutes, to the distillation temperature and subsequently is brought—where appropriate by active cooling back to the starting temperature of the prepolymer-containing reaction mixture prior to distillation. The temperature load traversed in this operation is preferably such that the temperature of the reaction mixtures prior to distillation or of the prepolymers after distillation as compared with the distillation temperature employed is at least 5° C., with particular preference at least 15° C., with very particular preference 15 to 40° C. higher.

Preferred continuous distillation techniques are short-path distillation, falling-film distillation and/or thin-film distillation (in this regard see, for example, Chemische Technik, Wiley-VCH, Volume 1, 5th Edition, pages 333-334).

Falling-film evaporators are composed of a vertical bundle of long tubes in which the liquid to be evaporated is fed in at the top and flows downwards as a film. In the jacket space, heating takes place by means of steam. Within the tubes, vapour bubbles are formed, which flow downwards with the liquid and ensure turbulent conditions. At the bottom end, vapour and liquid separate in a settling vessel.

Thin-film evaporators are apparatuses suitable for evaporating temperature-sensitive substances which can be subjected to a thermal load only for a short time. The liquid to be evaporated is fed at the top into the tube with jacket heating. It flows down the tube as a film. Within the tube a wiper, suspended from a shaft, rotates, and ensures a constant film thickness.

The continuous distillation technique used is preferably that of thin-film distillation with the aforementioned parameters.

The equivalents ratio of the NCO groups of component a) to the OH groups component b) in the reaction is preferably 10:1 to 2:1, with particular preference 7:1 to 3:1.

The reaction temperature selected is 0° C. to 250° C., preferably 20° C. to 140° C., with very particular preference 40° C. to 100° C.

Not only the reaction partners, but also the reaction product, are liquid at the chosen reaction temperature, so that it is possible to do without the use of additional solvents for homogenizing and lowering the viscosity of the reaction mixture. The process of the invention can also be carried out in the presence of solvents such as aromatics, chlorinated aromatics, esters or chlorinated HCs.

In order to accelerate the urethanization it is possible to use the conventional catalysts such as organometallic compounds, amines (tertiary amines for example) or metal compounds such as lead octoate, Mercury succinate, tin octoate or dibutyltin dilaurate. If catalysts are used they are added preferably in amounts of 0.001 to 5% by weight, in particular 0.002 to 2% by weight, based on the total amount of components a) and b) to be reacted.

It is preferred to use organometallic compounds, with particular preference organometallic catalysts from the group of tin(IV) compounds.

Particularly preferred catalysts from the group of the tin(IV) compounds are dibutyltin and dioctyltin diacetate, maleate, bis(2-ethylhexoate), dilaurate, dichloride, bisdodecylmercaptide, tributyltin acetate, bis(β-methoxycarbonyl-ethyl)tin dilaurate and bis(β-acetyl-ethyl)tin dilaurate.

A very particularly preferred organometallic catalyst is dibutyltin dilaurate.

Antioxidants can be added to the reaction mixture, preferably from the group of sterically hindered phenols or phosphorous esters.

The invention further provides for the use of the prepolymers of the invention for producing polyurethane plastics, paints, coatings, adhesives or sealants.

Sealants, adhesives, paints and coating materials based on the prepolymers of the invention can be put to diverse uses. They can be employed widely for the coating, bonding and sealing of materials comprising, for example, metal, ceramic, glass, plastic, wood, concrete and other construction materials or natural materials. The substrates referred to may where appropriate have been subjected to any necessary pre-treatment beforehand.

The invention accordingly further provides substrates provided with coatings obtainable using the prepolymers of the invention.

### EXAMPLES

Unless indicated otherwise, all percentages are by weight.

The NCO contents were determined by back-titrating dibutylamine, added in excess, with hydrochloric acid.

The viscosity measurement took place with a rotary viscometer from Haake at 23° C.

### Example 1

383.4 g of 2,4-TDI and 19 mg of isocyanatocaproyl chloride were charged to a vessel at 80° C. and a mixture of 485.6 g of polypropylene glycol having a molar mass of 2000 g/mol and a theoretical OH functionality of 2 with 131.0 g of polypropylene glycol having a molar mass of 1000 g/mol and a theoretical OH functionality was added thereto over the course of 2 h. Stirring was carried out until the NCO content was 15.4%. Then, in a thin-film evaporator under a vacuum of 0.1 mbar at a temperature of 140° C., the excess TDI was separated off.

The viscosity of the prepolymer was 6760 mPas and remained unchanged after 5 week's storage at 23° C. The NCO content of the prepolymer was 4.48% and fell after 5 week's storage to 4.40%.

### Example 2

The procedure described in Example 1 was repeated, but replacing the isocyanatocaproyl chloride by the same amount of ETS chloride, a mixture of 2-chlorocarbamoyl-ethylamino-4-isocyanatotoluene and 4-chlorocarbamoyl-ethylamino-2-isocyanatotoluene.

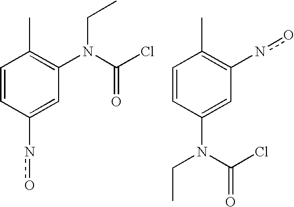

The viscosity of the prepolymer was 7090 mPas and rose after 5 week's storage at 23° C. to 7750 mPas. The NCO content of the prepolymer was 4.36% and remained unchanged after 5 week's storage.

### Example 3 (Comparative)

The procedure described in Example 1 was repeated, but replacing isocyanatocaproyl chloride with the same amount of titanium tetrachloride.

The viscosity of the prepolymer was 6840 mPas and rose after 5 week's storage at 23° C. to 7040 mPas. The NCO content of the prepolymer was 4.42% and remained unchanged after 5 week's storage.

### Example 4 (Comparative)

The procedure described in Example 1 was repeated, but replacing isocyanatocaproyl chloride with the same amount of benzoyl chloride.

The viscosity of the prepolymer was 7030 mPas and rose in just one week at 23° C. to 16100 mPas. The NCO content of the prepolymer was 4.42% and fell in just on week to 3.73%.

| | Viscosity [mPas] | | NCO content [%] | |
|---|---|---|---|---|
| | Start of | After 5 | Start of | After 5 |
| Chloride employed | measurement | weeks | measurement | weeks |
| Ex. 1 Isocaynatocaproyl | 6760 | 6760 | 4.48 | 4.40 |
| chloride | | | | |
| Ex. 2 ETS chloride | 7090 | 7750 | 4.36 | 4.36 |
| (carbamoyl chloride) | | | | |
| Ex. 3 (comp.) Titanium | 6840 | 7040 | 4.42 | 4.42 |
| tetrachloride | | | | |
| Ex. 4 (comp.) Benzoyl | 7030 | 16100 | 4.42 | 3.73 |
| chloride | | | | |

While in the case of Examples 1-3 the NCO content remains constant, or virtually constant, a marked loss of free NCO groups is apparent when using benzoyl chloride as stabilizer. In that case there is likewise an enormous viscosity rise of about 9000 mPas, whereas the viscosity when using the carbonyl chloride remains constant, and when using the carbamoyl chloride rises only by 660 mPas. The prepolymers of the invention exhibit a far higher storage stability in respect in particular of the viscosity.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Isocyanate-functional prepolymers comprising at least one structural unit of the general formula (I) or (II) 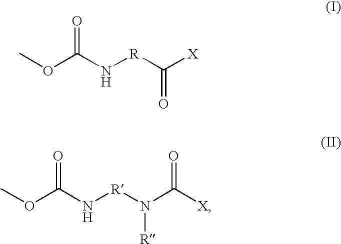
where
R and R′ independently of one another are a C₁ to C₁₂ alkylene, a C₅ to C₁₂ cycloalkylene or an optionally heteroatom-containing, aromatic hydrocarbon radical having 6 to 22 carbon atoms,
R″ is a C₁ to C₁₂ alkyl, a C₅ to C₁₂ cycloalkyl or an optionally heteroatom-containing, aromatic hydrocarbon radical having 6 to 22 carbon atoms, and
X is a halogen atom.

2. Isocyanate-functional prepolymers according to claim 1, in which R and R′ are each an o-, m or p-phenylene radical, a 1,5-pentylene radical or a 2,4- or 2,6-toluene radical, R″ is a C₁ to C₄-alkyl radical and X is Cl.

3. Process for preparing isocyanate-functional prepolymers according to claim 1, comprising reacting:
a) one or more polyisocyanates with
b) one or more polyols in the presence of
c) at least one isocyanatocarbonyl halide or isocyanatocarbamoyl halide of the general formula (III) or (IV), respectively 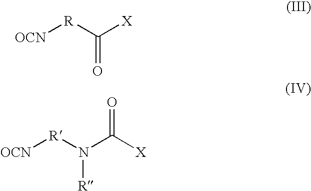
where
R and R′ independently of one another are a C₁ to C₁₂ alkylene, a C₅ to C₁₂ cycloalkylene or an optionally heteroatom-containing, aromatic hydrocarbon radical having 6 to 22 carbon atoms,
R″ is a C₁ to C₂ alkyl, a C₅ to C₁₂ cycloalkyl or an optionally heteroatom-containing, aromatic hydrocarbon radical having 6 to 22 carbon atoms, and
X is a halogen atom.

4. Process according to claim 3, wherein R and R′ are each an o-, m or p-phenylene radical, a 1,5-pentylene radical or a 2,4- or 2,6-toluene radical, R″ is a C₁ to C₄-alkyl radical and X is Cl.

5. Process according to claim 3, wherein the polyisocyanates are selected from the group consisting of hexamethylene diisocyanate, isophorone diisocyanate, the isomeric bis(4,4′-isocyanatocyclohexyl)methanes, TDI, MDI, and mixtures thereof.

6. Process according to claim 3, wherein the polyols are polyether-based polyols.

7. Process according to claim 3, wherein the isocyanatocarbonyl halide is selected from the group consisting of 6-isocyanatocaproyl chloride, 11-isocyanatoundecanoyl chloride, and o-, m- or p-isocyanatobenzoyl chloride.

8. Process according to claim 3, wherein the isocyanatocarbamoyl halide is selected from the group consisting of 2-chlorocarbamoyl-ethylamino-4-isocyanatotoluene and 4-chlorocarbamoyl-ethylamino-2-isocyanatotoluene.

9. Process according to claim 3, wherein the equivalents ratio of the NCO groups of component a) to the OH groups of component b) is from 7:1 to 3:1.

10. Polyurethane compositions obtained from isocyanate-functional prepolymers according to claim 1.

11. Polyurethane compositions according to claim 10, wherein the compositions are selected from the group consisting of plastics, paints, coatings, adhesives or sealants.

12. Substrates provided with coatings obtained from isocyanate-functional prepolymers according to claim 1.
